(19) United States
(12) Patent Application Publication
(10) Pub. No.: US 2026/0017925 A1
(43) Pub. Date: Jan. 15, 2026

(54) ENHANCED IMAGE AND VIDEO OBJECT DETECTION USING MULTI-STAGE PARADIGM

(71) Applicant: Intel Corporation, Santa Clara, CA (US)

(72) Inventors: Haoran Wei, Beijing (CN); Ping Guo, Beijing (CN); Peng Wang, Beijing (CN); Xiangbin Wu, Beijing (CN); Jiajie Wu, Shanghai (CN)

(73) Assignee: Intel Corporation, Santa Clara, CA (US)

(21) Appl. No.: 18/995,022

(22) PCT Filed: Sep. 9, 2022
(86) PCT No.: PCT/CN2022/118175

§ 371 Date: Jan. 15, 2025

(51) Int. Cl. G06V 10/766; G06V 10/25; G06V 10/778; G06V 10/82

(52) U.S. Cl. CPC G06V 10/766; G06V 10/25; G06V 10/778; G06V 10/82

(57) ABSTRACT

This disclosure describes systems, methods, and devices related to object detection in images. A device may input an image, representing an object, to a manual labeling learner system; identify, using the system, first coordinates of an upper left corner of a bounding box representing the object based on a heatmap indicative of a probability of the first coordinates representing the upper left corner; identify, using the system, second coordinates of a bottom right corner of the bounding box based on the first coordinates and a first distance regression map indicative of coordinate differences between the second coordinates and ground truth coordinates input to the machine learning model as training data; generate, using the system, adjustments to the first coordinates and the second coordinates based on a second regression map; and generate, using the system, the adjusted first and second coordinates, the bounding box.

### TECHNICAL FIELD

This disclosure generally relates to devices, systems, and methods for image processing and, more particularly, to an enhanced object detection in images using a multi-stage paradigm.

### BACKGROUND

Object detection in images and videos is a popular computer vision task, and has been widely used in various applications such as intelligent transportation, smart retail, robotics, and aerospace. There are different ways to classify existing methods such as anchor-based, anchor-free, center-guided, corner-guided. However, some object detectors do not generate high quality bounding boxes, which limits the application in scenarios where high quality bounding boxes are required, such as dense car localization in smart transportation applications.

### BRIEF DESCRIPTION OF THE DRAWINGS

FIG. 1A shows an example manual labeling learner system for enhanced object detection simulating manual object labeling, according to some example embodiments of the present disclosure.

FIG. 1B shows an example of the machine learning backbone of FIG. 1A, according to some example embodiments of the present disclosure.

FIG. 2 shows example processes for object detection, according to some example embodiments of the present disclosure.

FIG. 3A is an example image with multiple bounding boxes used for object detection, according to some example embodiments of the present disclosure.

FIG. 3B is an example image with multiple bounding boxes used for object detection, according to some example embodiments of the present disclosure.

FIG. 4 shows an example process for multi-stage manual labeling learning for enhanced object detection simulating manual object labeling, according to some example embodiments of the present disclosure.

FIG. 5 illustrates a flow diagram of an illustrative process for multi-stage manual labeling learning for enhanced object detection simulating manual object labeling, in accordance with one or more example embodiments of the present disclosure.

FIG. 6 illustrates an embodiment of an exemplary system, in accordance with one or more example embodiments of the present disclosure.

### DETAILED DESCRIPTION

The following description and the drawings sufficiently illustrate specific embodiments to enable those skilled in the art to practice them. Other embodiments may incorporate structural, logical, electrical, process, algorithm, and other changes. Portions and features of some embodiments may be included in, or substituted for, those of other embodiments. Embodiments set forth in the claims encompass all available equivalents of those claims.

Image and video processing (herein referred to as “image processing”) techniques such as computer vision often rely on bounding boxes as reference points for an object represented by an image. Bounding boxes may be generated based on the x and y coordinates of an upper left and bottom right corners of the bounding box (e.g., a corner-guided method) or by the x and y coordinates of a bounding box center (e.g., a center-guided method). Modern object detectors are usually center-guided or corner-guided. Center-guided detector is the most active branch in object detection community, such as Faster R-CNN (regions with convolutional neural networks) and DETR (detection transformer). They define a set of center locations (e.g., points/areas) as positive samples to directly regress the heights and widths of target objects. Corner-guided detectors estimate and extract corner keypoints upon heatmaps to decode object boxes.

The center point of an object box is not easy to locate accurately. This is because a center point of a bounding box needs to be determined by all four boundaries of the instance (needing four degrees of freedom), leading to this center-guided grouping-free manner is difficult to produce high-quality detection boxes, especially towards dense objects, small objects or occlusions. Compared to center-guided method, corner-guided methods are more able to find precise bounding box. However, current corner-guided method needs complex post processing such as groupings which induce high computational cost and high false positives.

The precision of a bounding box is important to object detection. For example, improperly identifying an object's location due to an imprecise bounding box may affect decisions that control a vehicle's operation. In particular, a high quality bounding box is crucial in dense or occluded localization scenarios (e.g., a traffic scenario with multiple cars whose entirety may not be visible to a vehicle camera).

Although some modern object detectors are not good at generating high quality bounding boxes, humans can label a bounding box precisely. Empirically, humans run two steps to locate an object bounding box manually: 1) click a mouse at the top-left corner of an object, and then drag the mouse to the bottom right corner; and 2) refine the corner positions to make the bounding box more precisely, if necessary.

Object detection therefore may be enhanced by using machine learning to simulate a human labeling process using a multi-step paradigm.

In one or more embodiments, an enhanced object detection in images using a multi-stage paradigm may be referred to as a manual labeling learner (MLL). The MLL may be a human-like object detector with two stages to simulate the two manual steps described above. Compared to the state-of-the-art detectors, the MLL provides a new paradigm with high bounding box quality. Our method is evaluated on the Microsoft Common Objects in Context (COCO) dataset. The MLL outperforms state-of-the-art methods (e.g., DETR/CornerNet) by a large margin with lower computational cost, especially towards dense or occluded objects. In particular, compared with FasterRCNN, which is a two-stage detector baseline, MLL provides mean average precision mAP@90 improving by 12.3% on COCO. MLL may be used in object detection applications such as smart transportation, retail, surveillance, and the like.

In one or more embodiments, MLL may represent a two-stage detector simulating the two steps in manual labeling. In the first stage, the MLL simulates the “click” and “drag” operations based on three output feature maps, i.e., a heatmap to estimate top-left corner coordinate, an offset map to refine the corner, and a distance map to regress the relative distance from bottom-right corner to top-left corner. In the second stage, MLL may extract Rols (Region of Intersect) upon box proposals generated in the first stage to refine the top-left and bottom-right corners. The first stage outputs three feature maps (e.g., modern detectors usually output four or six feature maps, in comparison), and the second stage outputs two feature maps.

In one or more embodiments, to simulate the click and drag operation, MLL may use a keypoint estimation method to model this procedure. MLL adopts a heatmap to predict and pinpoint the top-left corner. After locating the top-left location, the next procedure is to “drag” the mouse from the located top-left position to the bottom-right one. MLL may apply distance regression to output the route of “drag.” In particular, at each top-left coordinate, MLL may regress Δx and Δy pairs to point to the bottom-right coordinate. Empirically, it is difficult to label the bounding box precisely enough using a one-time operation. MLL therefore may include a second step to adjust the box boundary. In stage two, MLL may first extract Rol features upon proposed bounding boxes generated in the first stage. Then, MLL may use N cascaded blocks to refine the top-left and bottom-right corners.

In one or more embodiments, there are three inputs in the first stage of MLL: (a) Top-left corner heatmap: MLL predicts a heatmap to estimate top-left corner keypoints. Each pixel value in the output heatmap represents the confidence of being judged as a top-left corner defined as:

$${G}_{k} = exp ( - \frac{{( x - {x}_{m} )}^{2} + {( y - {y}_{m} )}^{2}}{{f ( object size )}^{2}} , \qquad ( 1 )$$

where (x, y) is a coordinate in the heatmap. (xₘ, yₘ) is the ground truth object top-left corner. MLL may utilize a distance-penalty-aware focal loss to learn the heatmap.

In one or more embodiments, the second input in the first stage of MLL is: (b) Top-left corner offset map: Due to the discretization during down sampling, multiple pixels on large maps project to the same pixel in small maps. Thus a remapping is added to adjust the top-left location. MLL may use an offset regression method in which a convolutional neural network predicts heatmaps to represent locations of corners of different image objects, and predicts embedding vectors for each corner so that the distance between two embeddings of two corners from a same object is small. The neural network also may predict offsets to slightly adjust the locations of the corners. Using the predicted heatmaps, embeddings, and offsets, MLL may apply a post-processing algorithm to generate bounding boxes.

In one or more embodiments, the second input in the first stage of MLL is: (c) Bottom-right corner distance regression map: To model the “drag” mouse procedure in manual labeling, MLL predicts the relative location for each bottom-right corner at the corresponding top-left corner location. MLL may adopt distance regression at the mapped grid center of the top-left corner in FPN (feature pyramid networks). The regression targets may the coordinate differences (Δx, Δy) between two corners, which is the width and height of the corresponding object:

$$( Δx , Δy ) = ( {x}_{br} - {x}_{m} , {y}_{br} - {y}_{m} ) , \qquad ( 2 )$$

where (x_{br}, y_{br}) is the coordinate of a bottom-right corner, and (xₘ, yₘ) is a ground-truth location (e.g., a mapped grid center in the feature map). In this part, MLL may utilize the GIoU (generalized intersection over union) loss as objective for training, aiming to supervise objects of different sizes with equal intensity:

$${ℒ}_{r} = \frac{1}{N} {\sum }_{i = 1}^{N} GIoU ( box ( Δx , Δ y ) , bo x ( \hat{Δ} x , \hat{Δ} y ) ) , \qquad ( 3 )$$

where (\hat{Δ}x, \hat{Δ}y) are predicted relative distance of the bottom-right corner and (Δx, Δy) are ground truth (e.g., training boxes labeled as ground truth boxes), box(·) represents a box constructed by the corresponding top-left/bottom-right corners, and N is the number of total number of object instances. In this manner, by selecting the bottom right corner based on the top left corner, rather than selecting the two corners individually, the MLL method simulates a user's manual click and drag operations, and improves accuracy with respect to selecting the two corners individually.

In one or more embodiments, the GIoU loss of Equation (3) above may be replaced with another loss function (e.g., IoU loss, etc.). The loss function may have the inputs of an estimated bounding box from MLL, and a ground truth bounding box, and the output may be a score indicating overlap between the estimated bounding box and the ground truth bounding box.

In one or more embodiments, the use of heatmaps and vector embeddings to predict the upper left and lower right corners of a bounding box may use the concept of corner pooling. Because a bounding box corner may be outside of an object (e.g., not part of the actual object), to determine whether a top left corner exists at a given location (e.g., x and y coordinates), MLL may look horizontally toward the right from the candidate upper left corner for the topmost boundary of the object, and may look vertically toward the bottom for the leftmost boundary of the object. A corner pooling layer of the convolutional neural network may input two feature maps. At each pixel location, the corner pooling layer may max-pool the feature vectors to the right from the first feature map, max-pool the feature vectors directly below from the second feature map, and then add the two pooled results together.

In one or more embodiments, the purpose of the second stage of MLL is to refine the top-left and the bottom-right corners. The second stage also provides category confidence for each detect box. MLL may use N cascaded (e.g., N=3) tiny convolution blocks to gradually improve the quality of the output bounding box. In each block, MLL may apply both regression and classification, as in Equation (4) below:

$$\{ \begin{matrix}\tilde{δ} x = \frac{{x}^{*} - x}{Δ x} ; \tilde{δ} y = \frac{{y}^{*} - y}{Δ y} \\ \tilde{Δ} x = log ( \frac{Δ {x}^{*}}{Δ x} ) ; \tilde{Δ} y = log ( \frac{Δ {y}^{*}}{Δ y} )\end{matrix} \qquad ( 4 )$$

where (\tilde{δ}x, \tilde{δ}y) and (\tilde{Δ}x, \tilde{Δ}y) are the refinement of the top-left and bottom-right corners.

In one or more embodiments, during the inference, MLL may define the detect box score as the geometric mean of the locate score and class score:

$$score = \sqrt{s ( x , y ) {s ( class )}_{m}} , \qquad ( 5 )$$

where s(x, y) is a locate score output in the first stage of top-left corner heatmap, and s(class)ₘ represents a classification confidence output in the second stage.

In one or more embodiments, to train the second stage, MLL may combine the Lr defined in Equation (3) with the smooth L1 loss:

$$loss = {αL}_{h - tl} + β {L}_{h - b r} + γ {L}_{r} \qquad ( 6 )$$

where α, β and γ are balance weights set experimentally. In an implementation, MLL may set them to 1, 1 and 0.001. Lₕ₋ₜₗ and L_{h-br} are the smooth L1 loss for the top left and bottom left offsets defined in Equation (4):

$${L}_{h - tl} = \frac{1}{N} {\sum }_{i = 1}^{N} smoothL 1 ( {o}_{i , tl} , ) \qquad ( 7 )$$

$${L}_{h - b r} = \frac{1}{N} {\sum }_{i = 1}^{N} smoothL 1 ( {o}_{i , b r} , ) \qquad ( 8 )$$

where N is the number of positives samples during training, o_{i,tl}=(δx, δy) is the ground truth offset, [symbol] =(\tilde{δ}x, \tilde{δ}y) is the estimated offset of top left corner, o_{i,br}=(Δx, Δy) is the ground truth offset, and [symbol] =(\tilde{Δ}x, \tilde{Δ}y) is the estimated offset of bottom right corner by stage two.

The performance of MLL has been compared to other detectors using a COCO dataset. As shown in Table 1 below, MLL achieves mAP of 51.6% under ResNeXt-101 backbone which outperforms state-of-the-art methods. Specifically, compared with the corner-guided CentripetalNet which enjoys current optimal corner grouping algorithm, MLL lifts 4.9% on mAP@50. Besides, compared with the center-guided Deformable DETR, MLL still achieves higher mAP@50. Compared to FasterRCNN which is a two-stage detector baseline, MLL boosts the mAP@90 by 9.8% and 12.3% with different backbones. There is reason to believe that the accuracy under higher IoUs (mAP75:95) of MLL surpasses the Deformable DETR by a large margin, which means that MLL may yield higher-quality detection boxes by finding the top-left corner location directly. Moreover, compared with mature two-stage detector Cascade R-CNN, MLL lifts the mAP@75 by 1.9%, which further shows that directly estimating corners is better for pinpointing the boundary of an object than centers.

TABLE 1
MLL Compared with Other Detectors In
Terms of Inference Speed Using COCO:

| Method: | FPS | AP | AP50 | AP75 | AP90 |
|---|---|---|---|---|---|
| RetinaNet-R50 | 12 | 38.7 | 58.0 | 41.5 | |
| Faster | 16 | 40.2 | 59.8 | 43.8 | 11.3 |
| R-CNN-R50 | | | | | |
| DETR-R50 | 7 | 43.3 | 63.1 | 45.9 | |
| Sparse | 14 | 42.8 | 61.2 | 45.7 | |
| R-CNN-R50 | | | | | |
| MLL-R50 | 23 | 43.9 | 60.6 | 48.3 | 20.1 |
| Sparse | 10 | 44.1 | 62.1 | 47.2 | |
| R-CNN-R101 | | | | | |
| DETR-R101 | 5 | 44.9 | 64.7 | 47.7 | |
| MLL-R101 | 18 | 47.1 | 65.0 | 51.6 | 23.6 |

(FPS: Frames per second).
(AP: Average Precedent - higher AP means a better bounding box).

The above descriptions are for purposes of illustration and are not meant to be limiting. Numerous other examples, configurations, processes, algorithms, etc., may exist, some of which are described in greater detail below. Example embodiments will now be described with reference to the accompanying figures.

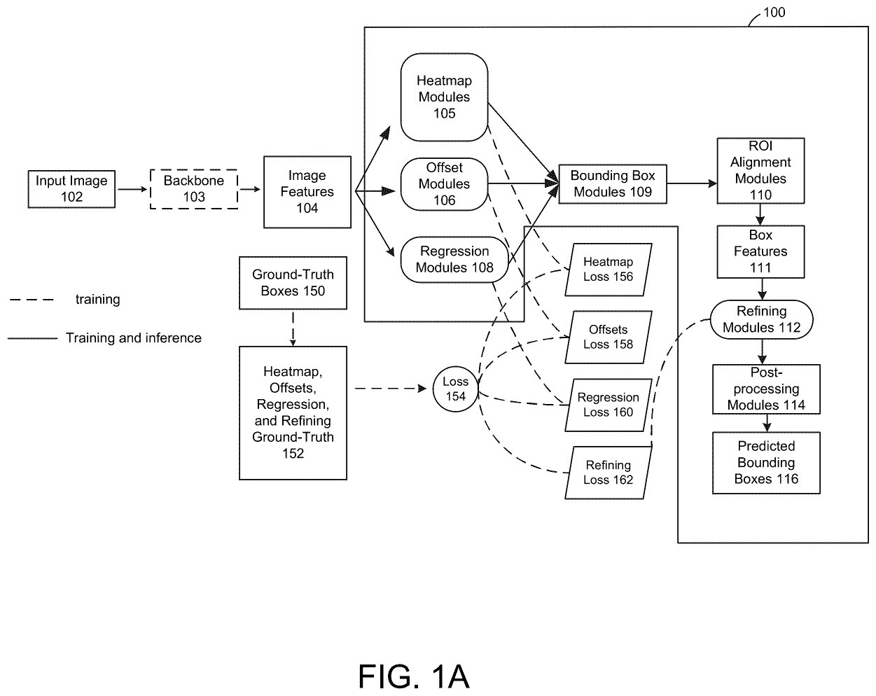

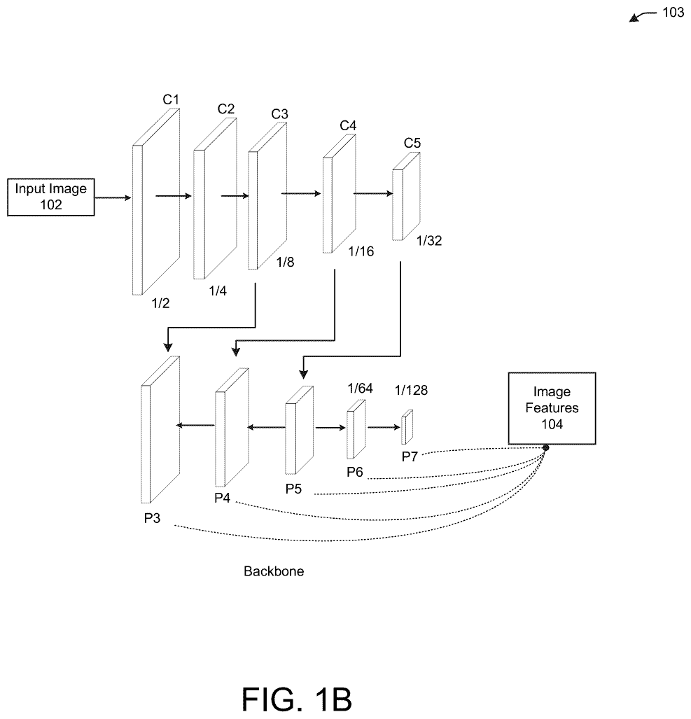

FIG. 1A shows an example multi-stage manual labeling learner system 100 for enhanced object detection simulating manual object labeling, according to some example embodiments of the present disclosure.

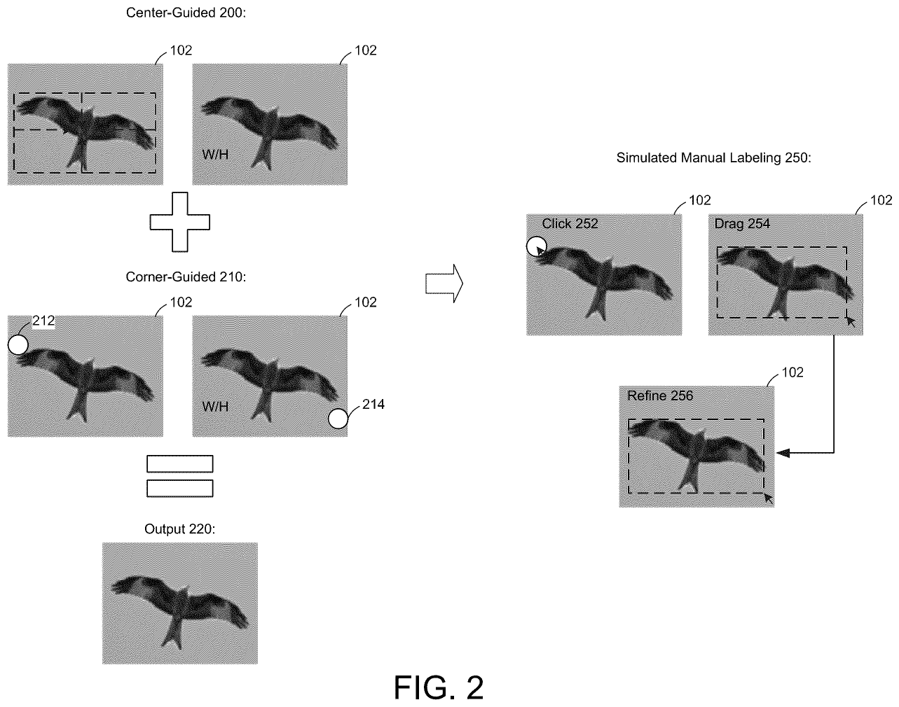

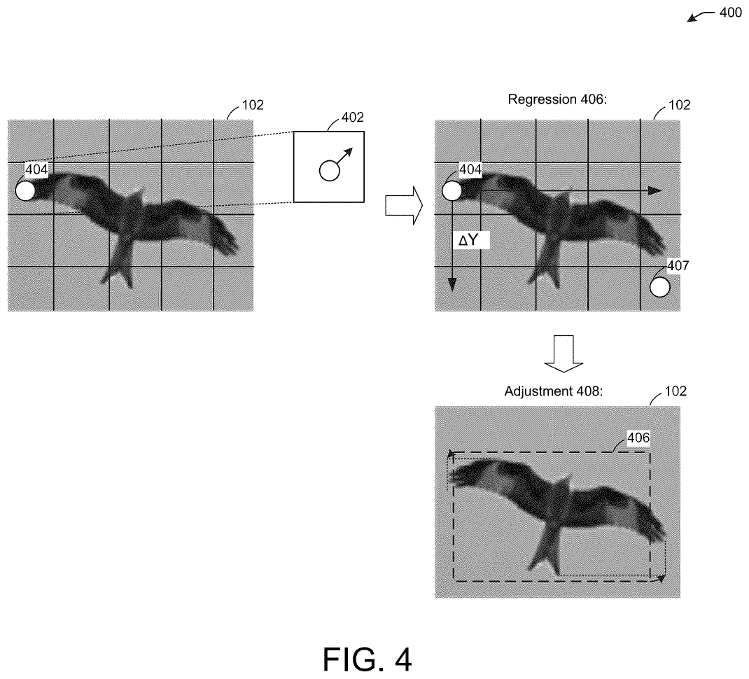

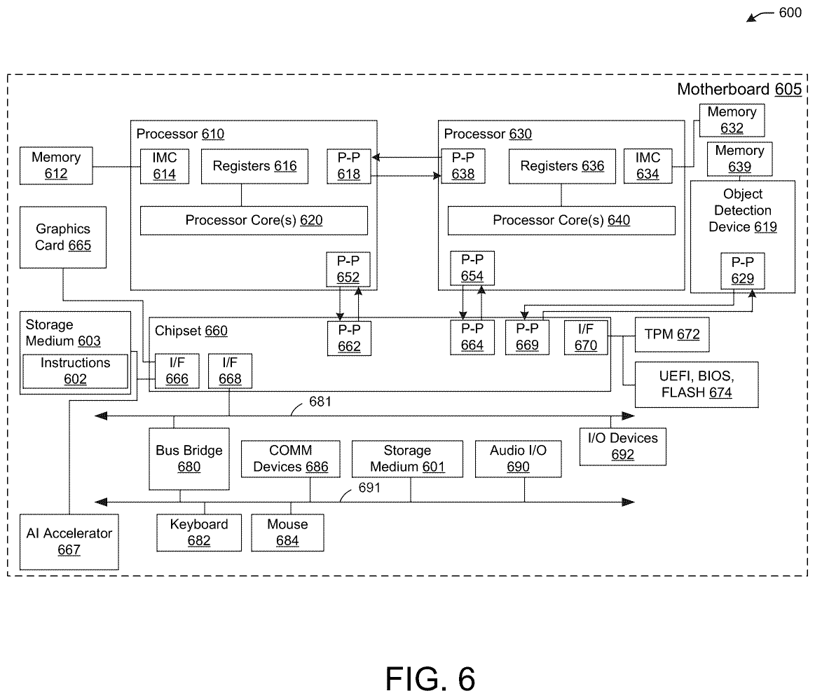

Referring to FIG. 1A, the multi-stage machine learning system 100 may include an input image 102 (e.g., representing an object, such as an eagle as shown) input to an optional ML backbone 103 (e.g., as described further with respect to FIG. 1B). The ML backbone 103 may be a multi-layered network for analyzing image features of the input image 102, and may generate, as an output, image features 104. For example, the image features 104 generated by the ML backbone 103 may include detected objects in the input image 102 and their locations in the input image 102, along with other features. Alternatively, the image features 104 may be input based on another analysis, manual or automatic (e.g., using computer vision or other object detection techniques). The image features 104 may be input to the multi-stage manual labeling learner system 100. The input image 102 may be captured by a camera (e.g., an I/O device 692 of FIG. 6). Stage 1 of the multi-stage manual labeling learner system 100 may include heatmap modules 105 for generating a heatmap for the input image 102 to simulate click and drag manual operations. The heatmap modules 105 may predict and pinpoint a top left corner of a bounding box used to identify the object in the input image 102 (e.g., as shown in FIG. 2) according to Equation (1) above. For example, for each point on the heatmap, the value may represent the probability that the upper left corner of the bounding box for the object is at that location (e.g., a locate score). Then, offset modules 106 of the multi-stage manual labeling learner system 100 may generate an offset map to refine the upper left corner of the bounding box (e.g., as shown in FIG. 4). Regression modules 108 of the multi-stage manual labeling learner system 100 may generate a regression map to model the drag procedure in manual labeling, predicting the relative location for a bottom right corner of the bounding box of the object shown in the input image 102. The regression map may apply Equations (2) and (3) above. The heatmap, offset map, and regression map may be input to bounding box modules 109 to generate estimated bounding boxes by applying the offset map to the estimated top left corner from the heatmap, and then applying the regression map to estimate the bottom right corner coordinates of the bounding box.

Still referring to FIG. 1A, the multi-stage manual labeling learner system 100 may include ROI alignment modules 110 to provide ROI alignment of proposed bounding boxes generated using Stage 1. The ROI alignment modules 110 may extract ROIs from proposed boxes generated using Stage 1 (e.g., the estimated bounding boxes of the bounding box modules 109). The ROI alignment may produce bounding box features 11, which may be refined by refining modules 112. Then, the multi-stage manual labeling learner system 100 may use N cascaded blocks from a convolution head of refining modules 112 (e.g., of multiple convolution heads of a neural network, in which each head may represent a convolution block at which both the regression map and the object classification may be applied to the bounding box generated from the upper left corner generated by the heatmap modules 105) to refine the upper left and bottom right corners, respectively, of any bounding boxes generated by Stage 1. Stage 2 may provide a category confidence for each detect box. The N cascaded blocks may be tiny convolution blocks to gradually improve the quality of the output bounding box. In each block, the multi-stage manual labeling learner system 100 may apply both regression and classification with post-processing modules 114 to generate predicted bounding boxes 116. During the inference, the multi-stage manual labeling learner system 100 may define the detected bounding box score as a geometric mean of a locate score and a class score (e.g., 95% confident that the object represented by the input image 102 is a bird in FIG. 1A), using Equation (5) above using the upper left and bottom right corner coordinates from the heatmap (e.g., x1, y1 representing the x and y coordinates of the upper left corner, and x2, y2 representing the x and y coordinates of the bottom right corner). The predicted bounding boxes 116 may be an output score according to Equation (5) above.

Still referring to FIG. 1A, ground-truth boxes 150 may be used as training to generate heatmaps, offsets, regression, and ground-truth refining. The heatmaps, offsets, regression, and ground-truth refining may be inputs to a loss function 154, which, when applied to the heatmaps, offsets, regression, and ground-truth refining, may result in a heatmap loss function 156, an offsets loss function 158, a regression loss function 160, and a refining loss function 162. The heatmap loss function 156, the offsets loss function 158, the regression loss function 160, and the refining loss function 162 may be training data inputs to the multi-stage manual labeling learner system 100. For example, the heatmap loss function 156 may be an input to the heatmap modules 105, the offsets loss function 158 may be input to the offset modules 106, and the refining loss funtion 162 may be input to the regression modules 108 to train the respective modules. The refining loss function 162 also may be input to the refining modules 112 as training data.

In one or more embodiments, due to the discretization during down sampling, multiple pixels on large maps project to the same pixel in small maps. Thus a remapping is added to adjust the top-left location. MLL may use an offset regression method in which a convolutional neural network (e.g., represented by the multi-stage manual labeling learner system 100 100) predicts heatmaps to represent locations of corners of different image objects, and predicts embedding vectors for each corner so that the distance between two embeddings of two corners from a same object is small The neural network also may predict offsets to slightly adjust the locations of the corners.

In one or more embodiments, the use of the heatmaps and vector embeddings to predict the upper left and lower right corners of a bounding box may use the concept of corner pooling. Because a bounding box corner may be outside of an object (e.g., not part of the actual object), to determine whether a top left corner exists at a given location (e.g., x and y coordinates), MLL may look horizontally toward the right from the candidate upper left corner for the topmost boundary of the object, and may look vertically toward the bottom for the leftmost boundary of the object. A corner pooling layer (e.g., one of the convolutional heads of the refining modules 112) of the convolutional neural network may input two feature maps. At each pixel location, the corner pooling layer may max-pool the feature vectors to the right from the first feature map, max-pool the feature vectors directly below from the second feature map, and then add the two pooled results together.

In one or more embodiments, the backbone 103 may be a ResNeXt-101 backbone (e.g., having 101 layers), R50 backbone (e.g., having 50 layers), or another type of backbone capable of extracting features from the pixels of the input image 102. The features may be used to generate the embedding vectors used by the heatmap modules 105 to generate candidate corners for the bounding box, which may be refined by the offset modules 106 and the regression modules 108. As shown above in Table 1, the more layers in the backbone 103, generally the better the multi-stage machine learning structure 100 is, especially for higher APₙ metrics. The multi-stage machine learning structure 100 may be trained with bounding boxes labeled as ground truth and with bounding boxes for various labeled objects.

FIG. 1B shows an example of the machine learning backbone 103 of FIG. 1A, according to some example embodiments of the present disclosure.

Referring to FIG. 1B, the input image 102 of FIG. 1A may be input to the backbone 103, which may include multiple feature layers (e.g., Cx and Px may represent corresponding features layers). The fractions (e.g., ½, ¼, ⅛, 1/16, 1/32, 1/64, 1/28, etc.) represent the magnification of the input image 102 at the respective layer. For example, at layer C1, the input image 102 may be magnified by ½, and so on, to generate the output image features 104. As shown, the machine learning backbone 103 is a R50 or ResNeXt 101 backbone, but other backbones may be used to generate the output image features 104. The backbone 103 may be trained using a dataset of images with classified objects (e.g., images with annotations identifying the objects).

FIG. 2 shows example processes for object detection, according to some example embodiments of the present disclosure.

Referring to FIG. 2, a center-guided process 200 for generating a bounding box and a corner-guided process 210 for generating a bounding box are shown in combination. As shown, the center-guided process 200 may search for the center of the object represented by the input image 102 of FIG. 1A (e.g., a bird) by defining a set of center locations as positive samples to directly regress the widths and heights (e.g., W/H) of target objects. The corner-guided process 210 may estimate and extract corner keypoints (e.g., upper left corner 212 and lower right corner 214) upon heatmaps to decode object bounding boxes. The output 220 may be difficult to generate accurately because the center point of a bounding box determined by the center-guided process 200 may need to be determined by all four boundaries, and the corner-guided 210 process may require complex post-processing.

Still referring to FIG. 2, a simulated manual labeling process 250 (e.g., MLL using the multi-stage machine learning structure 100 of FIG. 1A) may simulate a click 252 of the upper left corner of the object, and a drag operation 254 to the lower right corner of the object, and then refining 256 of the estimated bounding box (e.g., using the multi-stage machine learning structure 100 of FIG. 1A). Because the grouping of the center-guided process 200 and the corner-guided process 210 of FIG. 2, the simulated manual labeling process 250 may improve the bounding box detection because the bottom right corner may be determined based on the top left corner as the starting point for a simulated drag movement (e.g., rather than using separate heatmaps to estimate the top left and bottom right corners separately). The refining 256 (e.g., representing Stage 2 of FIG. 1A) may use N cascaded convolutional blocks of the multi-stage machine learning structure 100 to adjust the upper left and lower right corners. For each convolutional block, the refining 256 may include applying a regression and classification. For example, the regression may include a distance regression from an upper left or lower right corner to the x,y coordinate differences between the two corners (e.g., according to Equation (2) above).

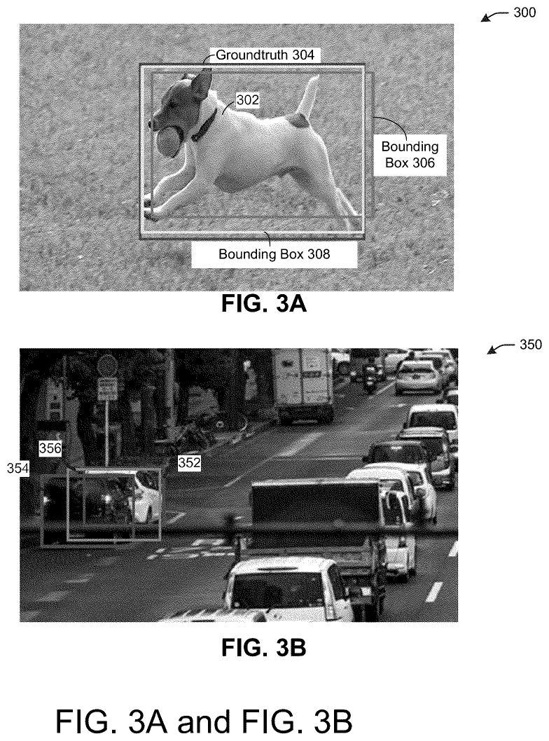

FIG. 3A is an example image 300 with multiple bounding boxes used for object detection, according to some example embodiments of the present disclosure.

Referring to FIG. 3A, the image represents a dog, and multiple true positive bounding boxes are shown under different metrics. A ground truth box 304 is shown along with a detected bounding box 306 and a detected bounding box 308. For example, the intersection of union (IOU) of the detected bounding box 306 and ground truth box 304 as shown may be around 0.75, and the IOU of the bounding box 308 and ground truth box 304 as shown may be around 0.9. Therefore, the detected bounding box 306 and the detected bounding box 308 may be regarded as true positives under mAP@50 (e.g., an IOU threshold with the ground truth box 304 of 0.5), but only the detected bounding box 308 may be regarded as a true positive under mAP@90.

FIG. 3B is an example image 350 with multiple bounding boxes used for object detection, according to some example embodiments of the present disclosure.

Referring to FIG. 3B, the image 350 is an example of a dense and occluded area. The bounding box 352 and the bounding box 354 may be ground truth boxes of two vehicles, and the box 356 may be a detected box (e.g., detected for the two vehicles) due to the occlusion. The IOU between the box 356 and each of the bounding box 352 and the bounding box 354 may be larger than 0.5, but the box 356 is not the true location of either of the vehicles. The occlusion caused by the density in the image 350 results in an inaccurate box 356 as the ground truth, and therefore the bounding box 352 and the bounding box 354 may be inaccurate.

Referring to FIGS. 3A and 3B, the need for MLL as the multi-stage machine learning structure 100 of FIG. 1A is shown to improve the way that a bounding box is generated for object detection.

Referring to FIG. 3B, the multi-stage machine learning structure 100 of FIG. 1A (and corresponding manual labeling process 250 of FIG. 2 and process 400 of FIG. 4) may improve the detected bounding box precision and speed even in the type of occluded image data shown in FIG. 3B. Table 1 above shows the improvement of the MLL technique described herein in comparison to other detectors.

FIG. 4 shows an example process 400 for multi-stage machine learning for enhanced object detection simulating manual object labeling, according to some example embodiments of the present disclosure.

Referring to FIG. 4, the process 400 may represent in more detail the multi-stage machine learning structure 100 of FIG. 1A. The process 400 may regress an offset 402 of a top left corner 404 (e.g., from the click step of FIG. 1A). The regression 406 may regress the relative distance (Δx, Δy) of a bottom right corner 407 from the top left corner 404. The process 400 may include an adjustment 408 to refine the top left corner 404 and the bottom right corner 407. The top left corner 404 may be determined according to Equation (1) above. The offset 402 may adjust for how multiple pixels on a large map may map to a same pixel in a smaller map by remapping the pixels to adjust the top left corner 404. The regression 406 may apply Equations (2) and (3) above, and the adjustment 408 may include applying Equation (4) above to refine the top left corner 404 and the bottom right corner 407.

In one or more embodiments, because a bounding box corner may be outside of an object (e.g., not part of the actual object), to determine whether a top left corner exists at a given location (e.g., x and y coordinates), the process 400 may look horizontally toward the right from the candidate upper left corner for the topmost boundary of the object, and may look vertically toward the bottom for the leftmost boundary of the object. A corner pooling layer (e.g., one of the convolutional heads of the refining modules 112 of FIG. 1A) of the convolutional neural network may input two feature maps. At each pixel location, the corner pooling layer may max-pool the feature vectors to the right from the first feature map, max-pool the feature vectors directly below from the second feature map, and then add the two pooled results together.

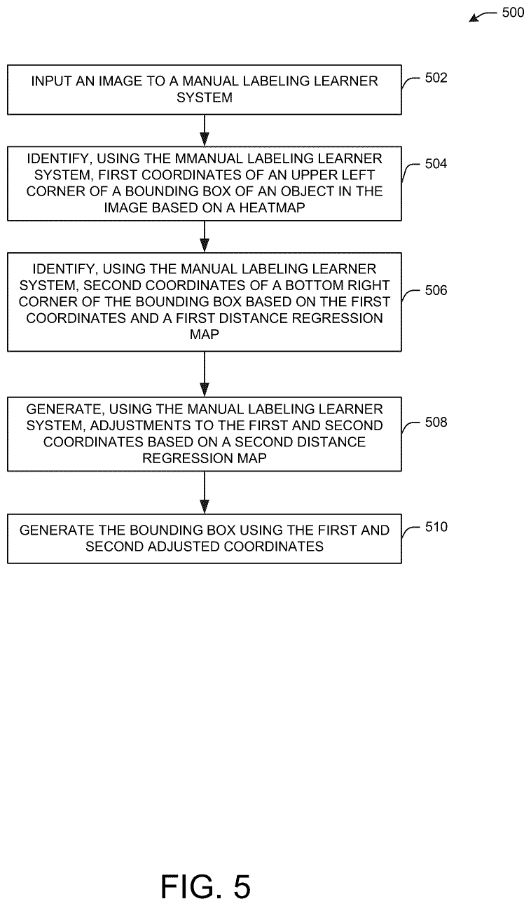

FIG. 5 illustrates a flow diagram of an illustrative process 500 for multi-stage machine learning for enhanced object detection simulating manual object labeling, in accordance with one or more example embodiments of the present disclosure.

At block 502, a device (e.g., the object device 619 of FIG. 6) may input an image (e.g., the input image 102 of FIG. 1A) to a machine learning model (e.g., the multi-stage machine learning structure 100 of FIG. 1A). The image may represent one or more objects to be detected using an image detection technique (e.g., computer vision or another technique) that may rely on a bounding box use to represent an object in the image. The machine learning model may be trained, using labeled ground truth coordinates and bounding boxes corresponding to different objects, to generate a bounding box for any object represented by the input image.

At block 504, the device may use the machine learning model to identify first coordinates (e.g., x,y coordinates) of an upper left corner (e.g., coordinates of top left corner 404 of FIG. 4) of a bounding box for an object in the image. The machine learning model may generate a heatmap for an image in which the values of the heatmap correspond to probabilities (e.g., a probability for each coordinate location in the heatmap) that the location is the upper left corner of the bounding box for the object.

At block 506, the device may use the machine learning model to identify second coordinates of a bottom right corner of the bounding box (e.g., the coordinates of the bottom right corner 407 of FIG. 4) based on the first coordinates. Rather than using the heatmap to separately predict the lower right corner coordinates and the upper left coordinates (e.g., using a corner-based and/or center-based technique), the machine learning model may use a distance regression map to model a “drag” procedure. The machine learning model may predict embedding vectors for each corner so that the distance between two embeddings of two corners from a same object is small. The neural network also may predict offsets to slightly adjust the locations of the corners. Using the predicted heatmaps, embeddings, and offsets, MLL may apply a post-processing algorithm to generate bounding boxes.

At block 508, the device may use the machine learning model to adjust (e.g., refine) the first and second coordinates. The machine learning model may use a second distance regression map to regress the distance between the ground truth coordinates and the first and second coordinates, resulting in a refining of the first and second coordinates to use for the bounding box at block 510. For example, the machine learning model may be trained using Equation (6) above.

It is understood that the above descriptions are for purposes of illustration and are not meant to be limiting.

FIG. 6 illustrates an embodiment of an exemplary system 600, in accordance with one or more example embodiments of the present disclosure.

In various embodiments, the computing system 600 may comprise or be implemented as part of an electronic device.

In some embodiments, the computing system 600 may be representative, for example, of a computer system that implements one or more components and/or performs steps of the processes of FIGS. 1-5.

The embodiments are not limited in this context. More generally, the computing system 600 is configured to implement all logic, systems, processes, logic flows, methods, equations, apparatuses, and functionality described herein and with reference to FIGS. 1-3B and 5.

The system 600 may be a computer system with multiple processor cores such as a distributed computing system, supercomputer, high-performance computing system, computing cluster, mainframe computer, mini-computer, client-server system, personal computer (PC), workstation, server, portable computer, laptop computer, tablet computer, a handheld device such as a personal digital assistant (PDA), or other devices for processing, displaying, or transmitting information. Similar embodiments may comprise, e.g., entertainment devices such as a portable music player or a portable video player, a smart phone or other cellular phones, a telephone, a digital video camera, a digital still camera, an external storage device, or the like. Further embodiments implement larger scale server configurations. In other embodiments, the system 600 may have a single processor with one core or more than one processor. Note that the term “processor” refers to a processor with a single core or a processor package with multiple processor cores.

In at least one embodiment, the computing system 600 is representative of one or more components of FIGS. 3A and 3B. More generally, the computing system 600 is configured to implement all logic, systems, processes, logic flows, methods, apparatuses, and functionality described herein with reference to the above figures.

As used in this application, the terms “system” and “component” and “module” are intended to refer to a computer-related entity, either hardware, a combination of hardware and software, software, or software in execution, examples of which are provided by the exemplary system 600. For example, a component can be, but is not limited to being, a process running on a processor, a processor, a hard disk drive, multiple storage drives (of optical and/or magnetic storage medium), an object, an executable, a thread of execution, a program, and/or a computer.

By way of illustration, both an application running on a server and the server can be a component. One or more components can reside within a process and/or thread of execution, and a component can be localized on one computer and/or distributed between two or more computers. Further, components may be communicatively coupled to each other by various types of communications media to coordinate operations. The coordination may involve the uni-directional or bi-directional exchange of information. For instance, the components may communicate information in the form of signals communicated over the communications media. The information can be implemented as signals allocated to various signal lines. In such allocations, each message is a signal. Further embodiments, however, may alternatively employ data messages. Such data messages may be sent across various connections. Exemplary connections include parallel interfaces, serial interfaces, and bus interfaces.

As shown in this figure, system 600 comprises a motherboard 605 for mounting platform components. The motherboard 605 is a point-to-point interconnect platform that includes a processor 610, a processor 630 coupled via a point-to-point interconnects as an Ultra Path Interconnect (UPI), and an object detection device 619 (e.g., capable of performing the functions of FIGS. 1-5). In other embodiments, the system 600 may be of another bus architecture, such as a multi-drop bus. Furthermore, each of processors 610 and 630 may be processor packages with multiple processor cores. As an example, processors 610 and 630 are shown to include processor core(s) 620 and 640, respectively. While the system 600 is an example of a two-socket (2S) platform, other embodiments may include more than two sockets or one socket. For example, some embodiments may include a four-socket (4S) platform or an eight-socket (8S) platform. Each socket is a mount for a processor and may have a socket identifier. Note that the term platform refers to the motherboard with certain components mounted such as the processors 610 and the chipset 660. Some platforms may include additional components and some platforms may only include sockets to mount the processors and/or the chipset.

The processors 610 and 630 can be any of various commercially available processors, including without limitation an Intel® Celeron®, Core®, Core (2) Duo®, Itanium®, Pentium®, Xeon®, and XScale® processors; AMD® Athlon®, Duron® and Opteron® processors; ARM® application, embedded and secure processors; IBM® and Motorola® DragonBall® and PowerPC® processors; IBM and Sony® Cell processors; and similar processors. Dual microprocessors, multi-core processors, and other multi-processor architectures may also be employed as the processors 610, and 630.

The processor 610 includes an integrated memory controller (IMC) 614 and point-to-point (P-P) interfaces 618 and 652. Similarly, the processor 630 includes an IMC 634 and P-P interfaces 638 and 654. The IMC's 614 and 634 couple the processors 610 and 630, respectively, to respective memories, a memory 612 and a memory 632. The memories 612 and 632 may be portions of the main memory (e.g., a dynamic random-access memory (DRAM)) for the platform such as double data rate type 3 (DDR3) or type 4 (DDR4) synchronous DRAM (SDRAM). In the present embodiment, the memories 612 and 632 locally attach to the respective processors 610 and 630.

In addition to the processors 610 and 630, the system 600 may include the object detection device 619. The object detection device 619 may be connected to chipset 660 by means of P-P interfaces 629 and 669. The object detection device 619 may also be connected to a memory 639. In some embodiments, the object detection device 619 may be connected to at least one of the processors 610 and 630. In other embodiments, the memories 612, 632, and 639 may couple with the processor 610 and 630, and the object detection device 619 via a bus and shared memory hub.

System 600 includes chipset 660 coupled to processors 610 and 630. Furthermore, chipset 660 can be coupled to storage medium 603, for example, via an interface (I/F) 666. The I/F 666 may be, for example, a Peripheral Component Interconnect-enhanced (PCI-c). The processors 610, 630, and the object detection device 619 may access the storage medium 603 through chipset 660.

Storage medium 603 may comprise any non-transitory computer-readable storage medium or machine-readable storage medium, such as an optical, magnetic or semiconductor storage medium. In various embodiments, storage medium 603 may comprise an article of manufacture. In some embodiments, storage medium 603 may store computer-executable instructions, such as computer-executable instructions 602 to implement one or more of processes or operations described herein, (e.g., process 500 of FIG. 5). The storage medium 603 may store computer-executable instructions for any equations depicted above. The storage medium 603 may further store computer-executable instructions for models and/or networks described herein, such as a neural network or the like. Examples of a computer-readable storage medium or machine-readable storage medium may include any tangible media capable of storing electronic data, including volatile memory or non-volatile memory, removable or non-removable memory, erasable or non-erasable memory, writeable or re-writeable memory, and so forth. Examples of computer-executable instructions may include any suitable types of code, such as source code, compiled code, interpreted code, executable code, static code, dynamic code, object-oriented code, visual code, and the like. It should be understood that the embodiments are not limited in this context.

The processor 610 couples to a chipset 660 via P-P interfaces 652 and 662 and the processor 630 couples to a chipset 660 via P-P interfaces 654 and 664. Direct Media Interfaces (DMIs) may couple the P-P interfaces 652 and 662 and the P-P interfaces 654 and 664, respectively. The DMI may be a high-speed interconnect that facilitates, e.g., eight Giga Transfers per second (GT/s) such as DMI 3.0. In other embodiments, the processors 610 and 630 may interconnect via a bus.

The chipset 660 may comprise a controller hub such as a platform controller hub (PCH). The chipset 660 may include a system clock to perform clocking functions and include interfaces for an I/O bus such as a universal serial bus (USB), peripheral component interconnects (PCIs), serial peripheral interconnects (SPIs), integrated interconnects (I2Cs), and the like, to facilitate connection of peripheral devices on the platform. In other embodiments, the chipset 660 may comprise more than one controller hub such as a chipset with a memory controller hub, a graphics controller hub, and an input/output (I/O) controller hub.

In the present embodiment, the chipset 660 couples with a trusted platform module (TPM) 672 and the UEFI, BIOS, Flash component 674 via an interface (I/F) 670. The TPM 672 is a dedicated microcontroller designed to secure hardware by integrating cryptographic keys into devices. The UEFI, BIOS, Flash component 674 may provide pre-boot code.

Furthermore, chipset 660 includes the I/F 666 to couple chipset 660 with a high-performance graphics engine, graphics card 665. In other embodiments, the system 600 may include a flexible display interface (FDI) between the processors 610 and 630 and the chipset 660. The FDI interconnects a graphics processor core in a processor with the chipset 660.

Various I/O devices 692 couple to the bus 681, along with a bus bridge 680 which couples the bus 681 to a second bus 691 and an I/F 668 that connects the bus 681 with the chipset 660. In one embodiment, the second bus 691 may be a low pin count (LPC) bus. Various devices may couple to the second bus 691 including, for example, a keyboard 682, a mouse 684, communication devices 686, a storage medium 601, and an audio I/O 690 (e.g., including one or more microphones).

The artificial intelligence (AI) accelerator 667 may be circuitry arranged to perform computations related to AI. The AI accelerator 667 may be connected to storage medium 603 and chipset 660. The AI accelerator 667 may deliver the processing power and energy efficiency needed to enable abundant-data computing. The AI accelerator 667 is a class of specialized hardware accelerators or computer systems designed to accelerate artificial intelligence and machine learning applications, including artificial neural networks and machine vision. The AI accelerator 667 may be applicable to algorithms for robotics, internet of things, other data-intensive and/or sensor-driven tasks.

Many of the I/O devices 692, communication devices 686, and the storage medium 601 may reside on the motherboard 605 while the keyboard 682 and the mouse 684 may be add-on peripherals. In other embodiments, some or all the I/O devices 692, communication devices 686, and the storage medium 601 are add-on peripherals and do not reside on the motherboard 605.

Some examples may be described using the expression “in one example” or “an example” along with their derivatives. These terms mean that a particular feature, structure, or characteristic described in connection with the example is included in at least one example. The appearances of the phrase “in one example” in various places in the specification are not necessarily all referring to the same example.

Some examples may be described using the expression “coupled” and “connected” along with their derivatives. These terms are not necessarily intended as synonyms for each other. For example, descriptions using the terms “connected” and/or “coupled” may indicate that two or more elements are in direct physical or electrical contact with each other. The term “coupled,” however, may also mean that two or more elements are not in direct contact with each other, yet still co-operate or interact with each other.

In addition, in the foregoing Detailed Description, various features are grouped together in a single example to streamline the disclosure. This method of disclosure is not to be interpreted as reflecting an intention that the claimed examples require more features than are expressly recited in each claim. Rather, as the following claims reflect, the inventive subject matter lies in less than all features of a single disclosed example. Thus, the following claims are hereby incorporated into the Detailed Description, with each claim standing on its own as a separate example. In the appended claims, the terms “including” and “in which” are used as the plain-English equivalents of the respective terms “comprising” and “wherein,” respectively. Moreover, the terms “first,” “second,” “third,” and so forth, are used merely as labels and are not intended to impose numerical requirements on their objects.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

A data processing system suitable for storing and/or executing program code will include at least one processor coupled directly or indirectly to memory elements through a system bus. The memory elements can include local memory employed during actual execution of the program code, bulk storage, and cache memories that provide temporary storage of at least some program code to reduce the number of times code must be retrieved from bulk storage during execution. The term “code” covers a broad range of software components and constructs, including applications, drivers, processes, routines, methods, modules, firmware, microcode, and subprograms. Thus, the term “code” may be used to refer to any collection of instructions that, when executed by a processing system, perform a desired operation or operations.

Logic circuitry, devices, and interfaces herein described may perform functions implemented in hardware and implemented with code executed on one or more processors. Logic circuitry refers to the hardware or the hardware and code that implements one or more logical functions. Circuitry is hardware and may refer to one or more circuits. Each circuit may perform a particular function. A circuit of the circuitry may comprise discrete electrical components interconnected with one or more conductors, an integrated circuit, a chip package, a chipset, memory, or the like. Integrated circuits include circuits created on a substrate such as a silicon wafer and may comprise components. Integrated circuits, processor packages, chip packages, and chipsets may comprise one or more processors.

Processors may receive signals such as instructions and/or data at the input(s) and process the signals to generate at least one output. While executing code, the code changes the physical states and characteristics of transistors that make up a processor pipeline. The physical states of the transistors translate into logical bits of ones and zeros stored in registers within the processor. The processor can transfer the physical states of the transistors into registers and transfer the physical states of the transistors to another storage medium.

A processor may comprise circuits to perform one or more sub-functions implemented to perform the overall function of the processor. One example of a processor is a state machine or an application-specific integrated circuit (ASIC) that includes at least one input and at least one output. A state machine may manipulate the at least one input to generate the at least one output by performing a predetermined series of serial and/or parallel manipulations or transformations on the at least one input.

The logic as described above may be part of the design for an integrated circuit chip. The chip design is created in a graphical computer programming language, and stored in a computer storage medium or data storage medium (such as a disk, tape, physical hard drive, or virtual hard drive such as in a storage access network). If the designer does not fabricate chips or the photolithographic masks used to fabricate chips, the designer transmits the resulting design by physical means (e.g., by providing a copy of the storage medium storing the design) or electronically (e.g., through the Internet) to such entities, directly or indirectly. The stored design is then converted into the appropriate format (e.g., GDSII) for the fabrication.

The resulting integrated circuit chips can be distributed by the fabricator in raw wafer form (that is, as a single wafer that has multiple unpackaged chips), as a bare die, or in a packaged form. In the latter case, the chip is mounted in a single chip package (such as a plastic carrier, with leads that are affixed to a motherboard or other higher-level carrier) or in a multichip package (such as a ceramic carrier that has either or both surface interconnections or buried interconnections). In any case, the chip is then integrated with other chips, discrete circuit elements, and/or other signal processing devices as part of either (a) an intermediate product, such as a processor board, a server platform, or a motherboard, or (b) an end product.

The word “exemplary” is used herein to mean “serving as an example, instance, or illustration.” Any embodiment described herein as “exemplary” is not necessarily to be construed as preferred or advantageous over other embodiments. The terms “computing device,” “user device,” “communication station,” “station,” “handheld device,” “mobile device,” “wireless device” and “user equipment” (UE) as used herein refers to a wireless communication device such as a cellular telephone, a smartphone, a tablet, a netbook, a wireless terminal, a laptop computer, a femtocell, a high data rate (HDR) subscriber station, an access point, a printer, a point of sale device, an access terminal, or other personal communication system (PCS) device. The device may be either mobile or stationary.

As used within this document, the term “communicate” is intended to include transmitting, or receiving, or both transmitting and receiving. This may be particularly useful in claims when describing the organization of data that is being transmitted by one device and received by another, but only the functionality of one of those devices is required to infringe the claim. Similarly, the bidirectional exchange of data between two devices (both devices transmit and receive during the exchange) may be described as “communicating,” when only the functionality of one of those devices is being claimed. The term “communicating” as used herein with respect to a wireless communication signal includes transmitting the wireless communication signal and/or receiving the wireless communication signal. For example, a wireless communication unit, which is capable of communicating a wireless communication signal, may include a wireless transmitter to transmit the wireless communication signal to at least one other wireless communication unit, and/or a wireless communication receiver to receive the wireless communication signal from at least one other wireless communication unit.

As used herein, unless otherwise specified, the use of the ordinal adjectives “first,” “second,” “third,” etc., to describe a common object, merely indicates that different instances of like objects are being referred to and are not intended to imply that the objects so described must be in a given sequence, either temporally, spatially, in ranking, or in any other manner.

Some embodiments may be used in conjunction with various devices and systems, for example, a personal computer (PC), a desktop computer, a mobile computer, a laptop computer, a notebook computer, a tablet computer, a server computer, a handheld computer, a handheld device, a personal digital assistant (PDA) device, a handheld PDA device, an on-board device, an off-board device, a hybrid device, a vehicular device, a non-vehicular device, a mobile or portable device, a consumer device, a non-mobile or non-portable device, a wireless communication station, a wireless communication device, a wireless access point (AP), a wired or wireless router, a wired or wireless modem, a video device, an audio device, an audio-video (A/V) device, a wired or wireless network, a wireless area network, a wireless video area network (WVAN), a local area network (LAN), a wireless LAN (WLAN), a personal area network (PAN), a wireless PAN (WPAN), and the like.

Some embodiments may be used in conjunction with one way and/or two-way radio communication systems, cellular radio-telephone communication systems, a mobile phone, a cellular telephone, a wireless telephone, a personal communication system (PCS) device, a PDA device which incorporates a wireless communication device, a mobile or portable global positioning system (GPS) device, a device which incorporates a GPS receiver or transceiver or chip, a device which incorporates an RFID element or chip, a multiple input multiple output (MIMO) transceiver or device, a single input multiple output (SIMO) transceiver or device, a multiple input single output (MISO) transceiver or device, a device having one or more internal antennas and/or external antennas, digital video broadcast (DVB) devices or systems, multi-standard radio devices or systems, a wired or wireless handheld device, e.g., a smartphone, a wireless application protocol (WAP) device, or the like.

Some embodiments may be used in conjunction with one or more types of wireless communication signals and/or systems following one or more wireless communication protocols, for example, radio frequency (RF), infrared (IR), frequency-division multiplexing (FDM), orthogonal FDM (OFDM), time-division multiplexing (TDM), time-division multiple access (TDMA), extended TDMA (E-TDMA), general packet radio service (GPRS), extended GPRS, code-division multiple access (CDMA), wideband CDMA (WCDMA), CDMA 2000, single-carrier CDMA, multi-carrier CDMA, multi-carrier modulation (MDM), discrete multi-tone (DMT), Bluetooth®, global positioning system (GPS), Wi-Fi, Wi-Max, ZigBee, ultra-wideband (UWB), global system for mobile communications (GSM), 2G, 2.5G, 3G, 3.5G, 4G, fifth generation (5G) mobile networks, 3GPP, long term evolution (LTE), LTE advanced, enhanced data rates for GSM Evolution (EDGE), or the like. Other embodiments may be used in various other devices, systems, and/or networks.

The following examples pertain to further embodiments.
Example 1 may be an apparatus for object detection in images, the apparatus comprising processing circuitry coupled to memory, the processing circuitry configured to: input image features an image, representing an object, to a manual labeling learner system; identify, using the manual labeling learner system, first coordinates of an upper left corner of a bounding box representing the object based on a heatmap indicative of a probability of the first coordinates representing the upper left corner; identify, using the manual labeling learner system, second coordinates of a bottom right corner of the bounding box based on the first coordinates and a first distance regression map indicative of coordinate differences between the second coordinates and ground truth coordinates input to the manual labeling learner system as training data; generate, using the manual labeling learner system, adjustments to the first coordinates and the second coordinates based on a second distance regression map; and generate, using the manual labeling learner system, the adjusted first coordinates, and the adjusted second coordinates, the bounding box for use in subsequent object detection for the image.
Example 2 may include the apparatus of example 1 and/or some other example herein, wherein a convolutional neural network with a backbone of at least fifty layers generates the image features.
Example 3 may include the apparatus of example 1 and/or some other example herein, wherein to identify the second coordinates comprises to determine a loss function of a first bounding box based on the ground truth coordinates and a second bounding box based on predicted distances between the first coordinates and third coordinates estimated for the bottom right corner.
Example 4 may include the apparatus of example 3 and/or some other example herein, wherein the loss function is an intersection of union loss function.
Example 5 may include the apparatus of example 4 and/or some other example herein, wherein the loss function is based on a summation of the intersection of union of the first bounding box and the second bounding box and a second intersection of unions of the first bounding box and a third bounding box based on predicted distances between the first coordinates and fourth coordinates estimated for the bottom right corner.
Example 6 may include the apparatus of any of examples 1-4 and/or some other example herein, wherein to identify the second coordinates comprises to: identify a first embedding vector indicative of first pixel features of the first coordinates; and identify, based on the first embedding vector, a second embedding vector indicative of second pixel features of the second coordinates.
Example 7 may include the apparatus of example 1 and/or some other example herein, wherein the processing circuitry is further configured to generate the heatmap based on an exponential function of a difference between the first coordinates and the ground truth coordinates.
Example 8 may include the apparatus of example 7 and/or some other example herein, wherein values of the heatmap correspond to respective coordinates and indicate a probability of the respective coordinates corresponding to the upper left corner.
Example 9 may include a non-transitory computer-readable storage medium comprising instructions to cause processing circuitry of a device for object detection in images, upon execution of the instructions by the processing circuitry, to: input image features of an image, representing an object, to a manual labeling learner system; identify, using the manual labeling learner system, first coordinates of an upper left corner of a bounding box representing the object based on a heatmap indicative of a probability of the first coordinates representing the upper left corner; identify, using the manual labeling learner system, second coordinates of a bottom right corner of the bounding box based on the first coordinates and a first distance regression map indicative of coordinate differences between the second coordinates and ground truth coordinates input to the manual labeling learner system as training data; generate, using the manual labeling learner system, adjustments to the first coordinates and the second coordinates based on a second distance regression map; and generate, using the manual labeling learner system, the adjusted first coordinates, and the adjusted second coordinates, the bounding box for use in subsequent object detection for the image.
Example 10 may include the non-transitory computer-readable medium of example 9 and/or some other example herein, wherein a convolutional neural network with a backbone of at least fifty layers generates the image features.
Example 11 may include the non-transitory computer-readable medium of example 9 and/or some other example herein, wherein to identify the second coordinates comprises to determine a loss function of a first bounding box based on the ground truth coordinates and a second bounding box based on predicted distances between the first coordinates and third coordinates estimated for the bottom right corner.
Example 12 may include the non-transitory computer-readable medium of example 11 and/or some other example herein, wherein the loss function is an intersection of union loss function.
Example 13 may include the non-transitory computer-readable medium of example 12 and/or some other example herein, wherein the loss function is based on a summation of the intersection of union of the first bounding box and the second bounding box and a second intersection of unions of the first bounding box and a third bounding box based on predicted distances between the first coordinates and fourth coordinates estimated for the bottom right corner.
Example 14 may include the non-transitory computer-readable medium of examples 9-13 and/or some other example herein, wherein to identify the second coordinates comprises to: identify a first embedding vector indicative of first pixel features of the first coordinates; and identify, based on the first embedding vector, a second embedding vector indicative of second pixel features of the second coordinates.
Example 15 may include the non-transitory computer-readable medium of example 9 and/or some other example herein, wherein execution of the instructions further causes the processing circuitry to generate the heatmap based on an exponential function of a difference between the first coordinates and the ground truth coordinates.
Example 16 may include the non-transitory computer-readable medium of example 15 and/or some other example herein, wherein values of the heatmap correspond to respective coordinates and indicate a probability of the respective coordinates corresponding to the upper left corner.
Example 17 may include a method for object detection in images, the method comprising: inputting, by processing circuitry of a device, images features of an image, representing an object, to a manual labeling learner system; identifying, using the manual labeling learner system, first coordinates of an upper left corner of a bounding box representing the object based on a heatmap indicative of a probability of the first coordinates representing the upper left corner; identifying, using the manual labeling learner system, second coordinates of a bottom right corner of the bounding box based on the first coordinates and a first distance regression map indicative of coordinate differences between the second coordinates and ground truth coordinates input to the manual labeling learner system as training data; generating, using the manual labeling learner system, adjustments to the first coordinates and the second coordinates based on a second distance regression map; and generating, using the manual labeling learner system, the adjusted first coordinates, and the adjusted second coordinates, the bounding box for use in subsequent object detection for the image.
Example 18 may include the method of example 17 and/or some other example herein, wherein a convolutional neural network with a backbone of at least fifty layers generates the image features, and wherein at least three of the layers are associated with adjusting the first coordinates and the second coordinates.
Example 19 may include the method of example 17 and/or some other example herein, wherein identifying the second coordinates comprises determining a loss function of a first bounding box based on the ground truth coordinates and a second bounding box based on predicted distances between the first coordinates and third coordinates estimated for the bottom right corner.
Example 20 may include the method of example 19 and/or some other example herein, wherein the loss function is an intersection of union loss function.
Example 21 may include the method of example 20 and/or some other example herein, wherein the loss function is based on a summation of the intersection of union of the first bounding box and the second bounding box and a second intersection of unions of the first bounding box and a third bounding box based on predicted distances between the first coordinates and fourth coordinates estimated for the bottom right corner.
Example 22 may include the method of any of examples 17-21 and/or some other example herein, wherein the loss function is based on a summation of the intersection of union of the first bounding box and the second bounding box and a second intersection of unions of the first bounding box and a third bounding box based on predicted distances between the first coordinates and fourth coordinates estimated for the bottom right corner.
Example 23 may include the method of example 17 and/or some other example herein, further comprising generating the heatmap based on an exponential function of a difference between the first coordinates and the ground truth coordinates.
Example 24 may include the method of example 17 and/or some other example herein, wherein values of the heatmap correspond to respective coordinates and indicate a probability of the respective coordinates corresponding to the upper left corner.
Example 25 may include an apparatus comprising means for: inputting images features of an image, representing an object, to a manual labeling learner system; identifying, using the manual labeling learner system, first coordinates of an upper left corner of a bounding box representing the object based on a heatmap indicative of a probability of the first coordinates representing the upper left corner; identifying, using the manual labeling learner system, second coordinates of a bottom right corner of the bounding box based on the first coordinates and a first distance regression map indicative of coordinate differences between the second coordinates and ground truth coordinates input to the manual labeling learner systemas training data; generating, using the manual labeling learner system, adjustments to the first coordinates and the second coordinates based on a second distance regression map; and generating, using the manual labeling learner system, the adjusted first coordinates, and the adjusted second coordinates, the bounding box for use in subsequent object detection for the image.
Example 26 may include one or more non-transitory computer-readable media comprising instructions to cause an electronic device, upon execution of the instructions by one or more processors of the electronic device, to perform one or more elements of a method described in or related to any of examples 1-25, or any other method or process described herein
Example 27 may include an apparatus comprising logic, modules, and/or circuitry to perform one or more elements of a method described in or related to any of examples 1-25, or any other method or process described herein.
Example 28 may include a method, technique, or process as described in or related to any of examples 1-25, or portions or parts thereof.
Example 29 may include an apparatus comprising: one or more processors and one or more computer readable media comprising instructions that, when executed by the one or more processors, cause the one or more processors to perform the method, techniques, or process as described in or related to any of examples 1-25, or portions thereof.

Embodiments according to the disclosure are in particular disclosed in the attached claims directed to a method, a storage medium, a device and a computer program product, wherein any feature mentioned in one claim category, e.g., method, can be claimed in another claim category, e.g., system, as well. The dependencies or references back in the attached claims are chosen for formal reasons only. However, any subject matter resulting from a deliberate reference back to any previous claims (in particular multiple dependencies) can be claimed as well, so that any combination of claims and the features thereof are disclosed and can be claimed regardless of the dependencies chosen in the attached claims. The subject-matter which can be claimed comprises not only the combinations of features as set out in the attached claims but also any other combination of features in the claims, wherein each feature mentioned in the claims can be combined with any other feature or combination of other features in the claims. Furthermore, any of the embodiments and features described or depicted herein can be claimed in a separate claim and/or in any combination with any embodiment or feature described or depicted herein or with any of the features of the attached claims.

The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Certain aspects of the disclosure are described above with reference to block and flow diagrams of systems, methods, apparatuses, and/or computer program products according to various implementations. It will be understood that one or more blocks of the block diagrams and flow diagrams, and combinations of blocks in the block diagrams and the flow diagrams, respectively, may be implemented by computer-executable program instructions. Likewise, some blocks of the block diagrams and flow diagrams may not necessarily need to be performed in the order presented, or may not necessarily need to be performed at all, according to some implementations.

These computer-executable program instructions may be loaded onto a special-purpose computer or other particular machine, a processor, or other programmable data processing apparatus to produce a particular machine, such that the instructions that execute on the computer, processor, or other programmable data processing apparatus create means for implementing one or more functions specified in the flow diagram block or blocks. These computer program instructions may also be stored in a computer-readable storage media or memory that may direct a computer or other programmable data processing apparatus to function in a particular manner, such that the instructions stored in the computer-readable storage media produce an article of manufacture including instruction means that implement one or more functions specified in the flow diagram block or blocks. As an example, certain implementations may provide for a computer program product, comprising a computer-readable storage medium having a computer-readable program code or program instructions implemented therein, said computer-readable program code adapted to be executed to implement one or more functions specified in the flow diagram block or blocks. The computer program instructions may also be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

Accordingly, blocks of the block diagrams and flow diagrams support combinations of means for performing the specified functions, combinations of elements or steps for performing the specified functions and program instruction means for performing the specified functions. It will also be understood that each block of the block diagrams and flow diagrams, and combinations of blocks in the block diagrams and flow diagrams, may be implemented by special-purpose, hardware-based computer systems that perform the specified functions, elements or steps, or combinations of special-purpose hardware and computer instructions.

Conditional language, such as, among others, “can,” “could,” “might,” or “may,” unless specifically stated otherwise, or otherwise understood within the context as used, is generally intended to convey that certain implementations could include, while other implementations do not include, certain features, elements, and/or operations. Thus, such conditional language is not generally intended to imply that features, elements, and/or operations are in any way required for one or more implementations or that one or more implementations necessarily include logic for deciding, with or without user input or prompting, whether these features, elements, and/or operations are included or are to be performed in any particular implementation.

Many modifications and other implementations of the disclosure set forth herein will be apparent having the benefit of the teachings presented in the foregoing descriptions and the associated drawings. Therefore, it is to be understood that the disclosure is not to be limited to the specific implementations disclosed and that modifications and other implementations are intended to be included within the scope of the appended claims. Although specific terms are employed herein, they are used in a generic and descriptive sense only and not for purposes of limitation

1-25. (canceled)

26. An apparatus for object detection in images, the apparatus comprising:
memory;
instructions; and
at least one processor circuit to be programmed based on the instructions to:
input image features of an image, representing an object, to a manual labeling learner system;
identify, based on the manual labeling learner system, first coordinates of an upper left corner of a bounding box representing the object, identification of the first coordinates based on a heatmap indicative of a probability of the first coordinates representing the upper left corner;
identify, based on the manual labeling learner system, second coordinates of a bottom right corner of the bounding box, identification of the second coordinates based on the first coordinates and a first distance regression map indicative of coordinate differences between the second coordinates and ground truth coordinates input to the manual labeling learner system as training data; and
generate, based on the manual labeling learner system, adjusted first coordinates and adjusted second coordinates of the bounding box based on a second distance regression map, the bounding box for use in subsequent object detection for the image.

27. The apparatus of claim 26, wherein one or more of the at least one processor circuit is to generate the image features based on a convolutional neural network with a backbone of at least fifty layers.

28. The apparatus of claim 26, wherein to identify the second coordinates, one or more of the at least one processor circuit is to determine a loss function of a first bounding box based on the ground truth coordinates and a second bounding box based on predicted distances between the first coordinates and third coordinates estimated for the bottom right corner.

29. The apparatus of claim 28, wherein the loss function is based on an intersection of union loss function.

30. The apparatus of claim 29, wherein the loss function is based on a summation of the intersection of union of the first bounding box and the second bounding box and a second intersection of unions of the first bounding box and a third bounding box based on predicted distances between the first coordinates and fourth coordinates estimated for the bottom right corner.

31. The apparatus of claim 26, wherein to identify the second coordinates, one or more of the at least one processor circuit is to:
identify a first embedding vector indicative of first pixel features of the first coordinates; and
identify, based on the first embedding vector, a second embedding vector indicative of second pixel features of the second coordinates.

32. The apparatus of claim 26, wherein one or more of the at least one processor circuit is to generate the heatmap based on an exponential function of a difference between the first coordinates and the ground truth coordinates.

33. The apparatus of claim 32, wherein values of the heatmap correspond to respective coordinates and indicate a probability of the respective coordinates corresponding to the upper left corner.

34. A non-transitory computer-readable storage medium comprising instructions to cause at least one processor circuit to at least:
input image features of an image, representing an object, to a manual labeling learner system;
identify, based on the manual labeling learner system, first coordinates of an upper left corner of a bounding box representing the object, identification of the first coordinates based on a heatmap indicative of a probability of the first coordinates representing the upper left corner;
identify, based on the manual labeling learner system, second coordinates of a bottom right corner of the bounding box, identification of the second coordinates based on the first coordinates and a first distance regression map indicative of coordinate differences between the second coordinates and ground truth coordinates input to the manual labeling learner system as training data; and
generate, based on the manual labeling learner system, adjusted first coordinates and adjusted second coordinates of the bounding box based on a second distance regression map, the bounding box for use in subsequent object detection for the image.

35. The computer-readable medium of claim 34, wherein the instructions are to cause one or more of the at least one processor circuit to generate the image features based on a convolutional neural network with a backbone of at least fifty layers generates the image features.

36. The computer-readable medium of claim 34, wherein to identify the second coordinates, the instructions are to cause one or more of the at least one processor circuit to determine a loss function of a first bounding box based on the ground truth coordinates and a second bounding box based on predicted distances between the first coordinates and third coordinates estimated for the bottom right corner.

37. The computer-readable medium of claim 36, wherein the loss function is based on an intersection of union loss function.

38. The computer-readable medium of claim 34, wherein to identify the second coordinates, the instructions are to cause one or more of the at least one processor circuit to:
identify a first embedding vector indicative of first pixel features of the first coordinates; and
identify, based on the first embedding vector, a second embedding vector indicative of second pixel features of the second coordinates.

39. The computer-readable medium of claim 34, wherein the instructions are to cause one or more of the at least one processor circuit to generate the heatmap based on an exponential function of a difference between the first coordinates and the ground truth coordinates.

40. A method for object detection in images, the method comprising:
inputting, by processor circuitry of a device, images features of an image, representing an object, to a manual labeling learner system;
identifying, using the manual labeling learner system, first coordinates of an upper left corner of a bounding box representing the object, identification of the first coordinates based on a heatmap indicative of a probability of the first coordinates representing the upper left corner;
identifying, using the manual labeling learner system, second coordinates of a bottom right corner of the bounding box, identification of the second coordinates based on the first coordinates and a first distance regression map indicative of coordinate differences between the second coordinates and ground truth coordinates input to the manual labeling learner system as training data; and
generating, using the manual labeling learner system, adjusted first coordinates and adjusted second coordinates of the bounding box based on a second distance regression map, the bounding box for use in subsequent object detection for the image.

41. The method of claim 40, including generating the image features using a convolutional neural network with a backbone of at least fifty layers, at least three of the layers associated with adjusting the first coordinates and the second coordinates.

42. The method of claim 40, wherein the identifying of the second coordinates includes determining a loss function of a first bounding box based on the ground truth coordinates and a second bounding box based on predicted distances between the first coordinates and third coordinates estimated for the bottom right corner.

43. The method of claim 42, wherein the loss function is based on an intersection of union loss function.

44. The method of claim 40, wherein the identifying of the second coordinates includes:
identifying a first embedding vector indicative of first pixel features of the first coordinates; and
identifying, based on the first embedding vector, a second embedding vector indicative of second pixel features of the second coordinates.

45. The method of claim 40, including generating the heatmap based on an exponential function of a difference between the first coordinates and the ground truth coordinates.
